(19) United States
(12) Patent Application Publication
(10) Pub. No.: US 2007/0061742 A1
(43) Pub. Date: Mar. 15, 2007

(54) Method, system, and program product for graphical authoring

(76) Inventors: Geoffrey S. Brooks, Niskayuna, NY (US); Thomas R. Carter, Mechanicville, NY (US); Louis A. DeSorbo, Niskayuna, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/212,155

(22) Filed: Aug. 26, 2005

(51) Int. Cl. G05B 11/01

(52) U.S. Cl. 715/763; 707/102; 700/18; 706/919; 715/967

(57) ABSTRACT

The present invention provides a method, system, and program product for querying a database and, optionally, producing a document including a result of the database query. The invention includes a graphical user interface (GUI) for assembling a graphical representation comprising one or more information controls, logical operator controls, and command controls. In a preferred embodiment, one or more of the information controls, logical operator controls, and command controls may be modified by a user to include a parameter. In one embodiment, the invention provides a graphical user interface (GUI) comprising: at least one information control identifying data in a database; at least one command control; and at least one logical operator control for connecting at least one of: a first information control and a command control; and a second information control and a third information control.

### BACKGROUND OF THE INVENTION

1. Technical Field

The invention relates generally to authoring tools and more particularly to the graphical authoring of structured documents.

2. Related Art

It is common in many fields and industries to utilize documents having a particular or predefined structure. In some cases, a document's structure may be industy-defined or established by statute or regulation (e.g., Material Safety Data Sheets (MSDSs)). When a document has a particular or predefined structure, a user may enter necessary data into a form or worksheet that already contains the structure. Doing so requires less time and effort than preparing the document “from scratch.” However, the preparation of some documents may require the entry of a large amount of necessary data. The preparation of some documents may require the entry of data contained within very large databases or located among disparate sources. In each case, a user must expend considerable time and effort entering or compiling the necessary data.

As a result, various methods have been developed in an attempt to lessen the time and effort involved in preparing such documents. For example, U.S. Patent Application Publication No. 20040012618 to Finney discloses a system and method for generating legal documents based on the legal proceeding's venue. A graphical user interface (GUI) allows a user to select the proceeding's venue and enter information in response to a predefined order of questions. U.S. Pat. No. 6,377,956 to Hsu et al. discloses a system for assembling product manuals based on various parameters, such as a product model. Data is retrieved from a database based upon user-inputted parameters.

Such systems and methods suffer from a number of deficiencies. First, the processes or rules by which data is retrieved from a database are not manipulable by a user. That is, the parameters and/or required fields are fixed within the system or method and are generally not variable. As such, the flexibility of such systems and methods in producing various structured documents is limited. Second, the accurate retrieval of information from a database and its incorporation into the document often require detailed knowledge of both the document structure and the database(s) containing the necessary data. End users of such systems or methods are often not those involved in the preparation of the document's structure or the databases used and therefore lack detailed knowledge of either. Third, where a document's structure and/or contents is dictated by one or more laws or regulations, proper production of the document requires complete and detailed understanding of the applicable law(s) and/or regulation(s), as well as any changes or amendments that may periodically be made to them. Few individuals, even those with knowledge of a document's structure and the relevant databases used in the document's preparation, have such knowledge of applicable laws and regulations. In addition, where the laws and/or regulations change frequently, implementation of the documents according to the laws and/or regulations is very cumbersome. For example, authoring such documents may require someone familiar with the applicable laws and/or regulations, the relevant database(s), and the software that generates the documents.

Accordingly, there is a need in the art for a method, system, and program product for querying a database and/or authoring a document that is manipulable by a user but does not require detailed knowledge of the document's structure, the software used to produce the document, or any databases containing data to be incorporated into the document.

### SUMMARY OF THE INVENTION

The present invention provides a method, system, and program product for querying a database and producing a document including a result of the database query. The invention includes a graphical user interface (GUI) for assembling a graphical representation comprising one or more information controls, logical operator controls, and command controls, the graphical representation providing a basis for constructing the structured document. In a preferred embodiment, one or more of the information controls, logical operator controls, and command controls may be modified by a user to include a parameter.

A first aspect of the invention provides a graphical user interface (GUI) comprising: at least one information control identifying data in a database; at least one command control; and at least one logical operator control for connecting at least one of: a first information control and a command control; and a second information control and a third information control.

A second aspect of the invention provides a method of graphically authoring at least a portion of a document, the method comprising: providing a graphical user interface (GUI) having: at least one information control identifying data in a database; at least one command control; and at least one logical operator control for connecting at least one of: a first information control and a command control; and a second information control and a third information control; permitting arrangement of the at least one information control, the at least one logical operator control, and the at least one command control to form a graphical representation of a rule; querying a database based upon the rule; and producing at least a portion of a document including a result of the querying step.

A third aspect of the invention provides a system for graphically authoring at least a portion of a document, the system comprising: means for providing a graphical user interface (GUI) having: at least one information control identifying data in a database; at least one command control; and at least one logical operator control for connecting at least one of: a first information control and a command control; and a second information control and a third information control; means for permitting arrangement of the at least one information control, the at least one logical operator control, and the at least one command control to form a graphical representation of a rule; means for querying a database based upon the rule; and means for producing at least a portion of a document including a result of the querying step.

A fourth aspect of the invention provides a program product stored on a computer-readable medium, which, when executed, produces at least a portion of a document, the program product code comprising: program code for providing a graphical user interface (GUI) having: at least one information control identifying data in a database; at least one command control; and at least one logical operator control for connecting at least one of: a first information control and a command control; and a second information control and a third information control; program code for permitting arrangement of the at least one information control, the at least one logical operator control, and the at least one command control within a process window to form a graphical representation of a rule; program code for querying a database based upon the rule; and program code for producing at least a portion of a document including a result of a database query.

The entire collection of controls and their related logic can be saved and persisted in a series of structured data elements enabling full or partial reuse of the docuemnt elements designed by the user.

The foregoing and other features of the invention will be apparent from the following more particular description of embodiments of the invention.

### BRIEF DESCRIPTION OF THE DRAWINGS

FIG. 1 shows an illustrative system according to one embodiment of the invention.

FIG. 2 shows a flow chart of a method according to one embodiment of the invention.

FIG. 3 shows a graphical user interface (GUI) according to one embodiment of the invention.

FIG. 4 shows a GUI including a graphical representation of a rule according to one embodiment of the invention.

FIG. 5 shows an illustrative database capable of use in practicing the invention.

FIG. 6 shows an illustrative document produced according to one embodiment of the invention.

FIG. 7 shows a partial graphical representation of a rule according to one embodiment of the invention.

### DETAILED DESCRIPTION

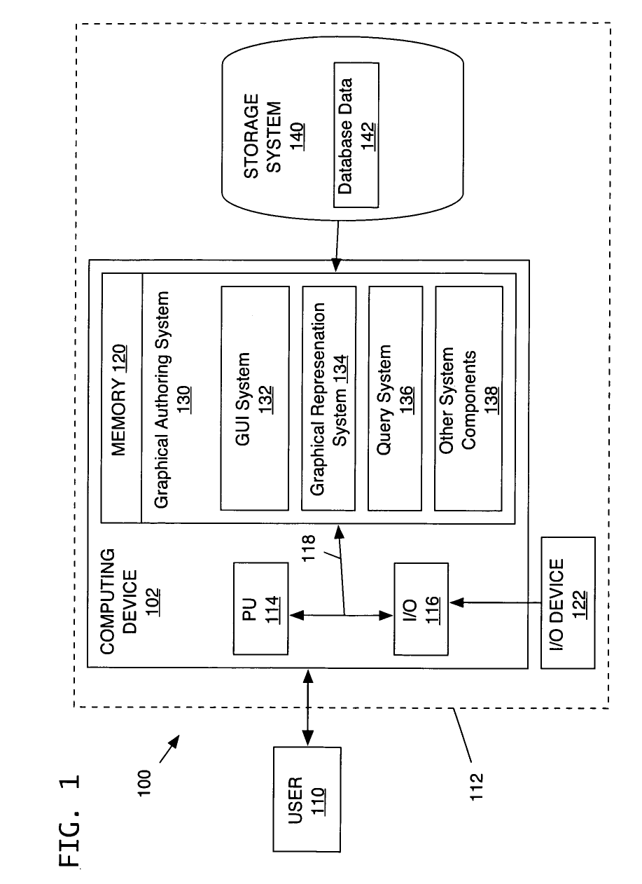

FIG. 1 shows an illustrative system 100 for graphically authoring a document. To this extent, system 100 includes a computer infrastructure 112 that can perform the various process steps described below for graphically authoring a document or database query. In particular, computer infrastructure 112 is shown including a computing device 102 that comprises a graphical authoring system 130, which enables computing device 102 to graphically author a document or database query by performing the process steps of the invention.

Computing device 102 is shown including a processor 114, a memory 120, an input/output (I/O) interface 116, and a bus 118. Further, computing device 102 is shown in communication with an external I/O device/resource 122 and a storage system 140. As is known in the art, in general, processor 114 executes computer program code, such as graphical authoring system 130, that is stored in memory 120 and/or storage system 140. While executing computer program code, processor 114 can read and/or write data to/from memory 120, storage system 140 (which may include, for example, database data 142), and/or I/O interface 116. Bus 118 provides a communication link between each of the components in computing device 102. I/O device 122 can comprise any device that enables user 110 to interact with computing device 102 or any device that enables computing device 102 to communicate with one or more other computing devices.

In any event, computing device 102 can comprise any general purpose computing article of manufacture capable of executing computer program code installed by a user 110 (e.g., a personal computer, server, handheld device, etc.). However, it is understood that computing device 102 and graphical authoring system 130 are only representative of various possible computing devices that may perform the various process steps of the invention. To this extent, in other embodiments, computing device 102 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 112 is only illustrative of various types of computer infrastructures for implementing the invention. For example, in one embodiment, computer infrastructure 112 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

Graphical authoring system 130 enables computing device 102 to graphically query a database and author a document. To this extent, graphical authoring system 130 is shown including a graphical user interface (GUI) system 132, a graphical representation system 134, and a query system 136. Operation of each of these systems is described in greater detail below. Other system components 138, such as document generation systems, database modifying systems, printing systems, rendering systems, transmission systems, etc., may similarly be included in graphical authoring system 130. It is understood that some of the various systems shown in FIG. 1 can be implemented independently, combined, and/or stored in memory for one or more separate computing devices 102 that communicate over a network. Further it is understood that some of the systems and/or functionality may not be implemented, or additional systems and/or functionality may be included as part of system 100.

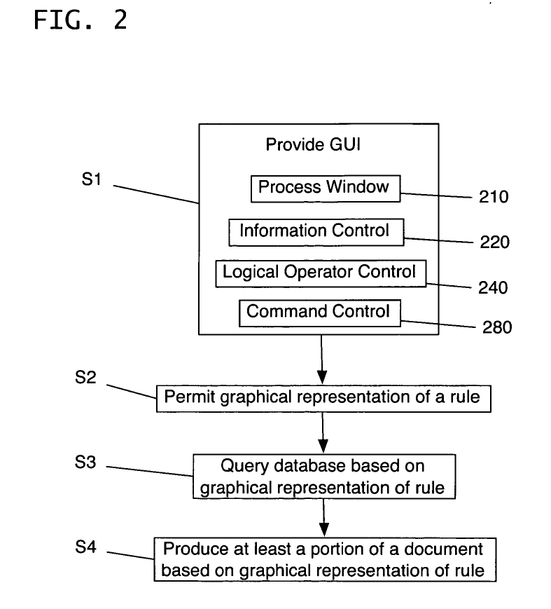

Referring now to FIG. 2, a flow chart 200 is shown for one embodiment of a method of graphically querying a database and authoring a document according to the present invention. First, at step S1, a graphical user interface (GUI) is provided to a user. GUI includes a process window 210, an information control 220, a logical operator control 240, and a command control 280, each of which is described in detail below.

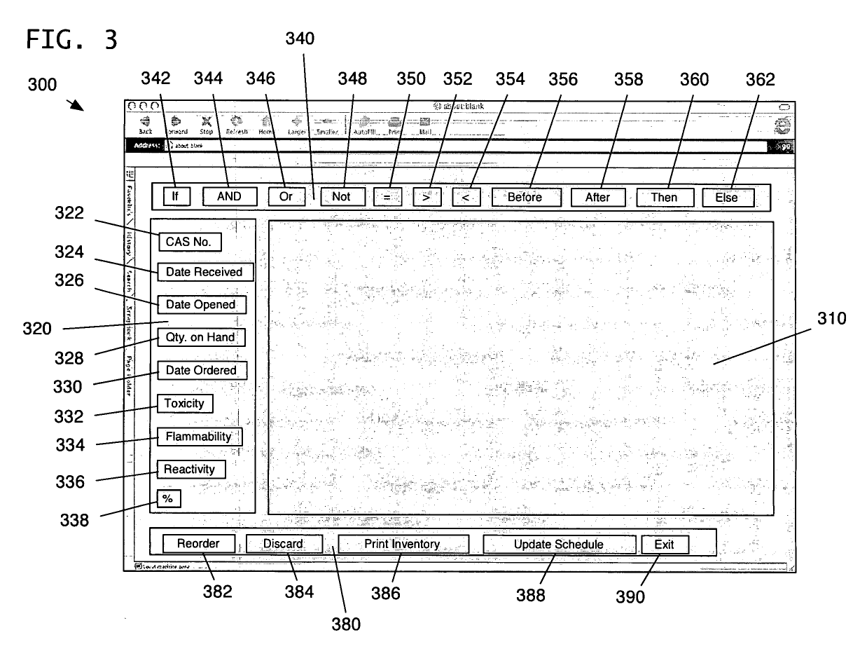

Referring to FIG. 3, a graphical user interface (GUI) 300 according to the present invention is shown. GUI 300 may be adapted or designed for any known or later-developed computer-based apparatus, computer language, and/or operating system.

GUI 300 includes a process window 310, an information control menu 320, a logical operator control menu 340, and a command control menu 380. Information control menu 320 includes a plurality of information controls 322-338, each control corresponding to a field or entry in one or more databases. Similarly, logical operator menu 340 includes a plurality of logical operator controls 342-362, each logical operator control corresponding to a logical operator or operators, including Boolean operators. Command control menu 380 includes a plurality of command controls 382-390, each command control corresponding to a computer program code. Such computer program may include executable program code for performing a task, including, for example, modifying other computer program code.

For example, as shown in the embodiment of FIG. 3, GUI 300 may be generated by a computer system (such as that of FIG. 1) operatively connected to, for example, a chemical inventory database (not shown). As such, information control menu 320 contains one or more information controls relating to fields or data within the chemical inventory database. For example, as shown, information control menu 320 includes information controls corresponding to Chemical Abstract Service (CAS) No. 322, Date Received 324, Date Opened 326, Quantity on Hand 328, Date Ordered 330, Toxicity 332, Flammability 334, Reactivity 336, and Percentage (%) 338. The information controls shown are merely illustrative. An information control according to the present invention may correspond to any field or entry in any database or other source of data. Accordingly, information controls allow a user of GUI 300 access to various fields or data of interest within the chemical inventory database.

Similarly, logical operator control menu 340 includes one or more logical operator controls for logically connecting one or more information controls, one or more command controls, and/or information controls and command controls. Logical operators may include Boolean operators (e.g., AND, OR, NOT, etc.) or other logical operators. For example, logical operator control menu 340 includes a plurality of logical operator controls corresponding to logical operators of: If 342, And 344, Or 346, Not 348, Equals (=) 350, Greater Than (>) 352, Less Than (<) 354, Before 356, After 358, Then 360, and Else 362. Other logical operator controls corresponding to other logical operators are possible, as would be known to one of ordinary skill in the art.

Command control menu 380 similarly includes one or more command controls. For example, command control menu 380 includes the following command controls: Reorder 382, Discard 384, Print Inventory 386, Update Schedule 388, and Exit 390. That is, command controls correspond to computer code for performing a task, preparing a document, or exiting the database and/or GUI 300. Such computer code may, for example, modify existing computer code. For example, computer code corresponding to a command control may include instructions to modify existing computer code to include data identified using a database query (described in greater detail below).

A document prepared according to the present invention is not limited to hard copy documents or their electronic equivalents. Rather, a document prepared according to the invention includes any medium for displaying, transmitting, documenting, or archiving information related to data within any database that is searchable using GUI 300. For example, a document prepared according to the present invention may comprise a display of information on a display apparatus of a computer system.

One or more information controls 322-338, logical operator controls 342-362, or command controls 382-390 may be added to process window 310 to construct a graphical representation of a rule (described in detail below) for querying a database, preparing a document relating to data within the database, and/or modifying data within the database. Information, logical operator, and command controls may be added to process window 310 by any known or later developed method, including, for example, selecting and clicking on the control using a computer keyboard or mouse, dragging the control to process window 310 using a mouse, or by speech recognition software.

Referring again to FIG. 2, at step S2, a user is permitted to assemble a graphical representation of a rule using one or more information control, logical operator control, and command control of the GUI. At step S3, a database is queried based upon the graphical representation of a rule assembled in step S2. At step S4, at least a portion of a document is produced including a result of the database query of step S3. A “document” of the present invention is intended to be broadly defined as any medium for providing information to an individual or system. Each step of FIG. 2 is described in greater detail below.

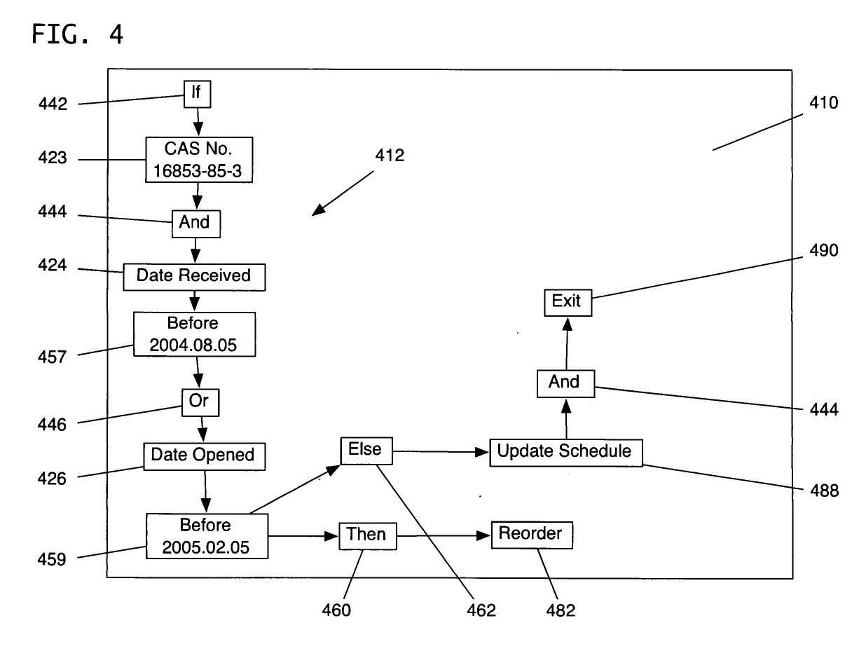

Referring now to FIG. 4, a graphical representation of a rule 412 is shown within process window 410. Graphical representation 412 includes a plurality of information controls 423, 424, 426, logical operator controls 442, 444, 457, 446, 459, 460, 462, 444, and command controls 482, 488, 490 arranged in a branched sequence. As such, graphical represention 412 comprises a logically-linked sequence of commands for querying a database, modifying the same or a different database, and preparing at least a portion of a document based upon both the query and modification of the databases. Generally, therefore, controls “downstream” in the process sequence include limitations of controls “upstream” in the graphical representation of the rule.

One or more command controls 482, 488, 490 may correspond to computer program code for modifying an existing computer program code. For example, Reorder 482 control may correspond to computer program code for accessing and modifying existing computer program code such as program code of an electronic mail program, whereby a result of a database query is included in an electronic message generated by the electronic mail program. In another embodiment, at least one of the graphical representation of the rule 412 and a result of a database query are incorporated into a document generation system, such that at least a portion of a document is produced based on the graphical representation of the rule 412 and/or the result of the database query.

In a preferred embodiment, one or more information control, logical operator control, and command control may be modified by a user to specify a parameter or parameters for querying the database(s), modifying the database(s), or preparing a document. This offers greater flexibility in the use of the present invention, permitting users with little or no detailed knowledge of the underlying databases to accurately construct queries and/or to produce documents or portions of documents from those databases. For example, information control 423 has been modified from its original form (322 in FIG. 3) to specify that the CAS No. is “16853-85-3.” Thus, commands and queries “downstream” of information control 423 in graphical representation 412 will be restricted to entries where the CAS No. is “16853-85-3.” It may be possible, of course, to assemble a different sequence of controls that achieves the same result. For example, rather than modifying information control 423 to specify that the CAS No. must be “16853-58-3,” a logical operator control such as Equals (=) (350 in FIG. 3) may be added after unmodified information control 423 and modified to specify the desired CAS No.

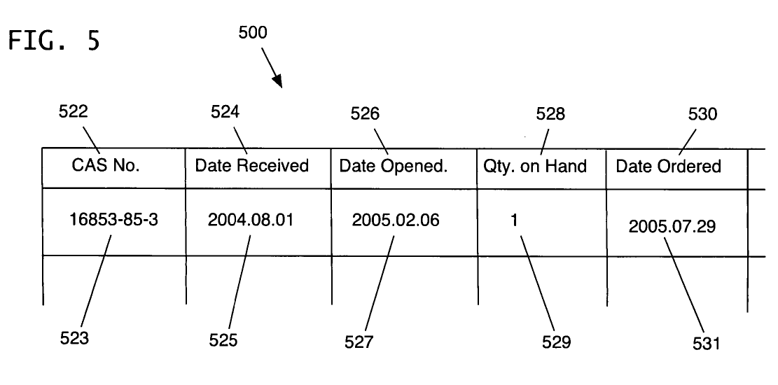

Still referring to FIG. 4, graphical representation 412 may be used, for example, to monitor a particular chemical within a chemical inventory database. As shown, CAS No. 16853-85-3 identifies lithium aluminum hydride (LAH), a particularly dangerous chemical that becomes more dangerous when contacted by water. Accordingly, a user may want to keep limited quantities of LAH on hand and discard any containers of LAH shortly after they are received and/or opened. Therefore, graphical representation 412 may be used to query a chemical inventory database (shown below in FIG. 5) for LAH having a Date Received 424 Before 457 Aug. 5, 2004 Or 446 a Date Opened 426 Before 459 Feb. 5, 2005. If the LAH in the database satisfies either of these parameters, it is targeted for Reorder 482. As described above, reordering may take any number of forms, including the printing of an order form, entry of a reorder request into a database, or an email to a vendor that includes ordering information. If neither parameter is satisfied, a schedule within a database is updated 488 and the database and/or GUI 300 (FIG. 3) is exited 490. The updated database may be the chemical inventory database or another database.

Referring now to FIG. 5, a representation of a chemical inventory database 500 is shown having fields 522, 524, 526, 528, 530 and entries 523, 525, 527, 529, 531 corresponding to the graphical representation 412 (FIG. 4). As shown, the CAS No. field 522 includes an entry 523 of “16853-85-3,” the Date Received field 524 includes an entry 525 of “2004.08.01,” and the Date Opened field 526 includes an entry 527 of “2005.02.06.” Thus, the information within chemical inventory database 500 satisfies one of the parameters of graphical representation 412 (FIG. 4) necessary to trigger reordering. Specifically, the entry 525 in the Date Received field 524 is before “2004.08.05.” Thus, LAH would be reordered, even though the entry 527 in the Date Opened field 526 is not before “2005.02.05,” and thus does not satisfy the parameter set by information control 459 (FIG. 4). Command control 482 (FIG. 4) may include computer code for entry of a reorder date 531 in chemical inventory database 500. Other parameters my be incorporated into graphical representation 412 (FIG. 4), including, for example, a parameter based upon an entry 529 in the Qty. on Hand field 528.

As noted above, the present invention may be used to produce or author any number of documents or portions of documents, including, for example, reports, schedules, letters, manuals, emails, etc. Similarly, the present invention may be used to produce such documents or portions of such documents from any type of database. For example, one type of document for which production or authoring according to the present invention is particularly beneficial is Material Safety Data Sheets (MSDSs). An MSDS generally includes a large amount of information and follows a standardized format. As such, production of an MSDS can be complicated and require a great deal of time. In addition, the production of an MSDS for a material comprised of a number of other materials must be based upon the MSDSs of those materials. This can be quite complicated and is a process prone to error or varying results, based upon the individual producing or authoring the MSDS.

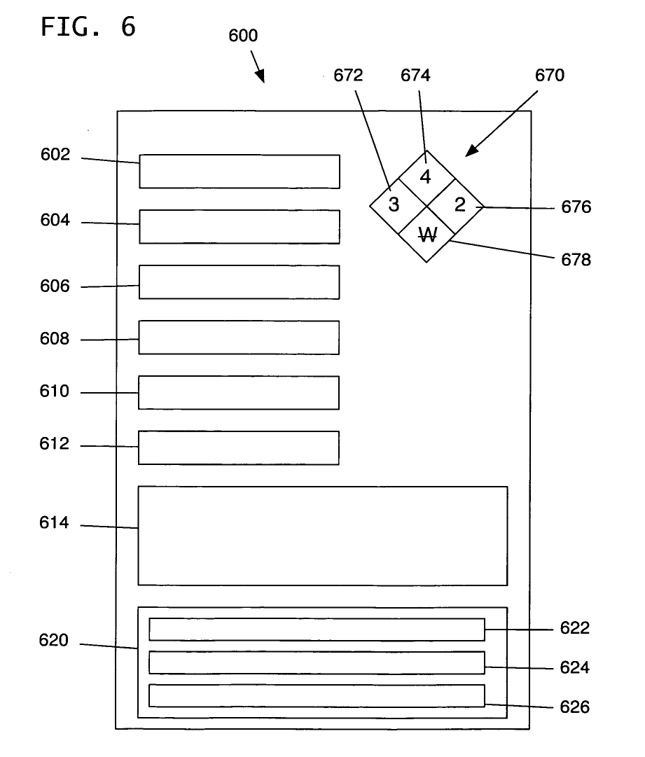

For example, FIG. 6 shows one page of an illustrative MSDS 600. In reality, an MSDS generally comprises multiple pages, often in excess of 10 pages. MSDS 600 includes a number of data fields 602, 604, 606, 608, 610, 612, 614, 620, each of which provides information about the particular material to which the MSDS applies. Standard MSDS formats organize material information into categories. Examples of common MSDS categories include chemical composition, hazard identification, first aid measures, fire fighting measures, accidental release measures, physical properties, handling and storage, exposure control/personal protection, physical and chemical properties, stability and reactivity, toxicological information, ecological information, disposal considerations, transport information, and regulatory information. Each category may in turn be divided into or include subcategories. For example, toxicological information generally includes subcategories for eye contact, skin contact, skin absorption, inhalation, ingestion, carcinogenicity, mutagenicity, and reproductive toxicity. As shown in FIG. 6, data field 620 includes subfields 622, 624, 626 corresponding to information subcategories of data field 620.

A particularly important and readily identifiable component of many MSDSs is a hazard diamond 670. Hazard diamond 670 provides ratings (on a 0 to 4 scale of increasing hazard) or other information in each of four categories. Hazard diamond 670 includes a subdiamond for each category: health 672, flammability 674, reactivity 676, and “special hazards” 678, which often includes information regarding unusual reactions or properties of the material. The rating in each subdiamond is based upon the material's hazardousness or potential hazardousness in each category. For example, the flammability subdiamond 674 for LAH is a “4,” indicating a material that will rapidly or completely vaporize at normal pressure and temperature and will bum readily. The special hazards subdiamond 678 includes a strikethrough “W,” indicating a material that will react violently with water.

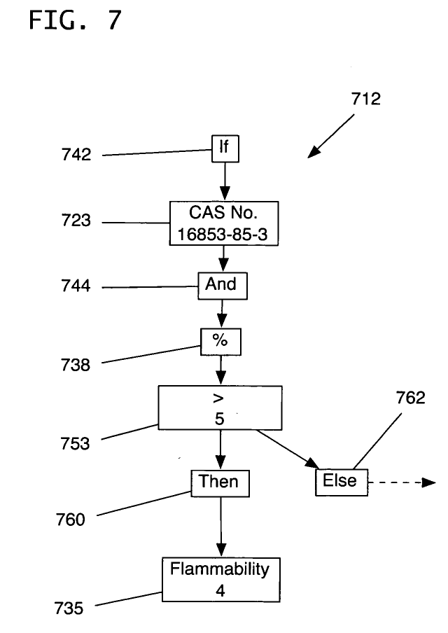

As noted above, a manufactured material may include a large number of components, each of which is represented by an MSDS. The process of determining information to be included in an MSDS for the manufactured material may be very complicated, the level of complication increasing with both the number of components and the differences between the individual MSDSs of each component. However, the present invention permits a user to graphically construct various rules for authoring an MSDS for the manufactured material. For example, referring to FIG. 7, a partial graphical representation 712 is shown having a group of information controls 723, 738, 735, and logical operator controls 742, 744, 753, 760, 762 comprising a rule for determining a flammability rating for a manufactured material. The rule requires that if the manufactured material includes a component with a CAS No. of “16853-85-3” that comprises greater than 5% of the manufactured material, the flammability rating with be “4.” Thus, regardless of the flammability ratings of other components of the manufactured material, the MSDS will include a flammability rating of “4” if LAH is present in an amount greater than 5%. Additional rules may then follow the “Else” logical operator control 762, which, together, may provide a graphical assembly of rules for authoring a complete MSDS for the manufactured material. The particular rules may be determined by a user, by statute or regulation, or by any other organization or entity. In the case that a particular rule is determined and/or required by statute or regulation (and therefore should not be altered by a user), GUI 300 (FIG. 3) may include a single control representing the rule and is capable of performing the functions of one or more informational, logical, or command controls.

While shown and described herein as a method and system for graphically authoring a document, it is understood that the invention further provides various alternative embodiments. For example, in one embodiment, the invention provides a computer-readable medium that includes computer program code to enable a computer infrastructure to graphically author a document or database query. To this extent, the computer-readable medium includes program code, such as graphical authoring system 130 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 1) and/or storage system 140 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to graphically query a database and, optionally, author a document as described below. In this case, the service provider can create, maintain, support, etc., a computer infrastructure, such as computer infrastructure 112 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for graphically authoring a document. In this case, a computer infrastructure, such as computer infrastructure 112 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 102 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A graphical user interface (GUI) comprising:
at least one information control identifying data in a database;
at least one command control; and
at least one logical operator control for connecting at least one of:
a first information control and a command control; and
a second information control and a third information control.

2. The GUI of claim 1, wherein at least one of the at least one information control, the at least one logical operator control, and the at least one command control is adapted to be modified by a user to include at least one parameter.

3. The GUI of claim 1, wherein the at least one information control, the logical operator control, and the command control are adapted to be arranged to form a graphical representation of a rule.

4. The GUI of claim 1, wherein the at least one command control includes computer code for querying a database.

5. The GUI of claim 1, wherein the at least one command control includes computer code for producing at least a portion of a document.

6. The GUI of claim 5, wherein the document includes at least one of the following: a material safety data sheet, a report, a schedule, a letter, an email, and a display.

7. The GUI of claim 5, wherein the document includes a predefined structure.

8. The GUI of claim 1, wherein the at least one command control includes computer code for modifying an existing computer code.

9. A method of graphically authoring at least a portion of a document, the method comprising:
providing a graphical user interface (GUI) having:
at least one information control identifying data in a database;
at least one command control; and
at least one logical operator control for connecting at least one of:
a first information control and a command control; and
a second information control and a third information control;
permitting arrangement of the at least one information control, the at least one logical operator control, and the at least one command control to form a graphical representation of a rule;
querying a database based upon the rule; and
producing at least a portion of a document including a result of the querying step.

10. The method of claim 9, further comprising the step of incorporating at least one of the rule and the result of the querying step into a document generation system.

11. The method of claim 9, wherein the document includes at least one of the following: a material safety data sheet, a report, a schedule, a letter, an email, and a display.

12. The method of claim 9, wherein the document includes a predefined structure.

13. The method of claim 9, wherein the at least one command control includes computer code for modifying an existing computer code.

14. A computer-readable medium for enabling a computer infrastructure to graphically author a document, the computer-readable medium comprising computer program code for performing the method steps of claim 9.

15. A system for graphically authoring at least a portion of a document, the system comprising:
means for providing a graphical user interface (GUI) having:
at least one information control identifying data in a database;
at least one command control; and
at least one logical operator control for connecting at least one of:
a first information control and a command control; and
a second information control and a third information control;
means for permitting arrangement of the at least one information control, the at least one logical operator control, and the at least one command control to form a graphical representation of a rule;
means for querying a database based upon the rule; and
means for producing at least a portion of a document including a result of the querying step.

16. The system of claim 15, further comprising means for incorporating at least one of the rule and the result of the querying step into a document generation system.

17. The system of claim 15, wherein the document includes at least one of the following: a material safety data sheet, a report, a schedule, a letter, an email, and a display.

18. The system of claim 15, wherein the document includes a predefined structure.

19. The system of claim 15, wherein the at least one command control includes computer code for modifying an existing computer code.

20. A program product stored on a computer-readable medium, which, when executed, produces at least a portion of a document, the program product code comprising:
program code for providing a graphical user interface (GUI) having:
at least one information control identifying data in a database;
at least one command control; and
at least one logical operator control for connecting at least one of:
a first information control and a command control; and
a second information control and a third information control;
program code for permitting arrangement of the at least one information control, the at least one logical operator control, and the at least one command control within a process window to form a graphical representation of a rule;
program code for querying a database based upon the rule; and
program code for producing at least a portion of a document including a result of a database query.

21. The program product of claim 20, further comprising program code for incorporating at least one of the rule and the result of a database query into a document generation system.

22. The program product of claim 20, wherein the document is at least one of the following: a material safety data sheet, a report, a schedule, a letter, an email, and a display.

23. The program product of claim 20, wherein the document includes a predefined structure.
